(19) United States
(12) Patent Application Publication
(10) Pub. No.: US 2007/0069630 A1
(43) Pub. Date: Mar. 29, 2007

(54) Image display device

(76) Inventors: Yuuichi Kijima, Chosei (JP); Shigemi Hirasawa, Chiba (JP); Yoshie Kodera, Chigasaki (JP); Tetsu Ohishi, Hiratsuka (JP)

Correspondence Address: REED SMITH LLP, Suite 1400, 3110 Fairview Park Drive, Falls Church, VA, 22042, US

(21) Appl. No.: 11/527,380

(22) Filed: Sep. 27, 2006

(30) Foreign Application Priority Data
Sep. 28, 2005 (JP) 2005-281845

(51) Int. Cl. H01J 63/04

(52) U.S. Cl. 313/495; 313/311

(57) ABSTRACT

In an image display device which includes a frame body which is arranged between a back substrate and a face substrate, a phosphor screen which is arranged on the face substrate, and an anode lead line for introducing a high voltage which is arranged between the phosphor screen and a voltage source, the anode lead line is covered with at least a portion of the frame body. According to the present invention, it is possible to obtain an image display device having a prolonged lifetime and capable of performing a high quality display while ensuring the conduction of a high voltage which is applied to a phosphor screen side.

### BACKGROUND OF THE INVENTION

1. Field of the Invention

The present invention relates to a planar image display device, and more particularly to an image display device which can enhance dielectric strength thereof.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar image display device (flat panel display, FPD) which is light-weighted and requires a small space for installation while ensuring the excellent properties such as high brightness and high definition.

As typical examples of such a planar image display device, a liquid crystal display device, a plasma display device or the like has been put into practice. Further, particularly with respect to the planar image display device which can realize the high brightness, various types of planar image displays such as a self-luminous display device (for example, a so-called electron emission type image display device, a field emission type image display device or the like) which makes use of emission of electrons into vacuum from electron sources, an organic EL display which is characterized by low power consumption are also expected to be put into practice in near future.

Among these planar image display devices, with respect to the self-luminous flat panel display, there has been known a display device having the constitution in which electron sources are arranged in a matrix array.

In the self-luminous flat panel display, as cold cathodes, thin film electron sources of a Spindt type, a surface conduction type, a carbon nanotubes type, an MIM (Metal-Insulator-Metal) type which laminates a metal layer, an insulator and a metal layer, an MIS (Metal-Insulator-Semiconductor) type which laminates a metal layer, an insulator and a semiconductor layer, a metal-insulator-semiconductor -metal type or the like have been used.

With respect to the MIM type electron source, for example, there has been known an electron source which is disclosed in JP-A-7-65710 (patent document 1) and JP-A-10-153979 (patent document 2). Further, with respect to the metal-insulator-semiconductor type electron source, there has been known an MOS type electron source reported in j. Vac. Sci. Technol. B11 (2) p. 429-432 (1993). (document 1). Further, with respect to the metal-insulator-semiconductor-metal type electron source, there has been known a HEED type electron source reported in high-efficiency-electro-emission device, Jpn. J. Appl. Phys. vol 36, pL939 (document 2), an EL type electron source reported in Electroluminescence, Applied Physics, Volume 63, No. 6, p. 592 (document 3), or a porous silicon type electron source reported in Applied Physics, Volume 66, No. 5, p. 437 (document 4).

As the planar image display device, there has been known a display panel which includes a back substrate having the above-mentioned electron sources, a face substrate which includes phosphor layers and anodes which form accelerating electrodes for allowing electrons emitted from the electron sources to impinge on the phosphor layers and is arranged to face the back substrate, and a frame body which forms a sealing frame for creating a predetermined vacuum state in an inner space defined between both substrates which face each other. The display device is operated by combining a drive circuit to the display panel.

The image display device having the MIM type electron sources includes a back substrate which forms, on the back substrate thereof, a large number of first lines (for example, referred to as cathode lines, video signal lines) which extend in the first direction and are arranged in parallel in the second direction which intersects the first direction, an insulation film which is formed in a state that the insulation film covers the first lines, a large number of second lines (for example, referred to as gate lines, scanning signal lines) which extend in the second direction and are arranged in parallel in the first direction over the insulation film, and electron sources which are provided in the vicinity of intersecting portions of the first lines and the second lines. The back substrate includes a substrate made of an insulating material and the above-mentioned lines are formed on the substrate.

In such a constitution, a scanning signal is sequentially applied to the scanning signal lines in another direction. Further, on the substrate, the above-mentioned electron source is provided in each intersecting portion of the scanning signal line and the image signal line. These both lines and the electron source are connected with each other using a power supply line so that an electric current is supplied to the electron source. A face substrate is arranged to face the back substrate in an opposed manner, wherein phosphor layers of plural colors and a front electrode (anode) are formed on an inner surface of the face substrate which faces the back substrate in an opposed manner. The face substrate is made of a light-transmitting material which is preferably glass. Further, by arranging the frame body between both substrates thus sealing a space defined between both substrates, and the inside which is formed by the back substrate, the face substrate and the frame body is evacuated and hence, a display panel is constituted.

The electron source is provided in the vicinity of the intersecting portion of the first line and the second line as mentioned above. An emission quantity of electrons from the electron source (including the turning on and off of the emission) is controlled based on a potential difference between the first line and the second line. The emitted electrons are accelerated due to a high voltage applied to the anode formed on the face substrate, and impinge on phosphor layers also formed on the face substrate thus exciting the phosphor layers and the light of colors corresponding to lights emitting characteristics of the phosphor layers are generated.

The individual electron source forms a pair with a corresponding phosphor layer so as to constitute a unit pixel. Usually, one pixel (color pixel, pixel) is constituted of the unit pixels of three colors consisting of red (R), green (G) and blue (B). Here, in the case of the color pixel, the unit pixel is also referred to as a sub pixel.

In the planner image display device described above, in general, in the inside of a space which is arranged between the back substrate and the face substrate and is surrounded by the frame body, a plurality of distance holding members (hereinafter referred to as spacers) are arranged and fixed. The distance between the above-mentioned both substrates is held at a predetermined distance in cooperation with the frame body. The spacers are formed of a plate-like body which is made of an insulating material such as glass, ceramics or the like, in general. Usually, the spacers are arranged at positions which do not impede an operation of pixels for every plurality of pixels.

Further, the frame body is fixed to inner peripheries of the back substrate and the face substrate using a sealing material such as frit glass, and the fixing portions are hermetically sealed thus forming sealing regions. The degree of vacuum in the inside of a display region defined by both substrates and the frame body is set to 10⁻⁵ to 10⁻⁷ Torr, for example.

First line lead terminals which are connected to the first lines formed on the back substrate and second line lead terminals which are connected to the second lines formed on the back substrate penetrate the sealing regions defined by the frame body and both substrates. Usually, the frame body is fixed to the back substrate and the face substrate using the sealing material such as frit glass or the like. The first line lead terminals and the second line lead terminals are pulled out through the sealing region which constitutes the hermetic sealing portion defined by the frame body and the back substrate.

Further, as another voltage supply means, for example, “patent document3” discloses a field emission type image display device which includes a connection means, wherein an anode lead has one end thereof brought into pressure contact with an anode terminal of an anode formed on an inner surface of a face panel and another end thereof pulled out to the outside by allowing another end to hermetically penetrate a getter chamber. Further, “patent document 4” discloses an image forming device in which an anode lead which has one end thereof connected to a lead-out line of an anode formed on an inner surface of a face panel has another end thereof pulled out to the outside in a state that another end hermetically penetrates a back panel.

Further, “patent document 5” and “patent document 6” disclose an image forming device in which an anode lead having one end thereof connected to an anode terminal of an anode formed on an inner surface of a face panel is pulled out to the outside by allowing the anode lead to pass through a through hole formed in a corner portion of a back panel by way of an insulation member. Further, “patent document 7” discloses an image display device in which an anode lead having one end thereof connected to an anode terminal of an anode formed on an inner surface of a face panel is pulled out to the outside by allowing the anode lead to pass through the inside of an insulation body which is formed in a through hole formed in a back panel.

[Patent Document 1] JP-A-7-65710

[Patent Document 2] JP-A-10-153979

[Patent Document 3] JP-A-10-31433

[Patent Document 4] JP-A-10-326581

[Patent Document 5] JP-A-2000-260359

[Patent Document 6] JP-A-2003-92075

[Patent Document 7] JP-A-2000-311636

[Document 1] j. Vac. Sci. Technol. B11 (2) p. 429-432 (1993)

[Document 2] high-efficiency-electro-emission device, Jpn. J. Appl. Phys. vol 36, pL939

[Document 3] Electroluminescence, Applied Physics, Volume 63, No. 6, p. 592

[Document 4] Applied Physics, Volume 66, No. 5, p. 437

### SUMMARY OF THE INVENTION

In the above-mentioned related art, the planar image display device adopts the constitution which introduces a high voltage to a face substrate. The face substrate constitutes an image viewing screen and hence, the face substrate is, in general, configured to introduce a line into a tube from a back substrate side and connects the line to an anode formed on the face substrate. A means which connects and applies the introduced high voltage to the anode of the face substrate, as also described in the above-mentioned patent documents, adopts the constitution in which, for example, a distal end of an anode lead which is fixed to the back substrate side is brought into pressure contact with an anode thin film which is formed on an inner surface of the face substrate by coating.

This constitution is an excellent means since a distance between both substrates is set to a value which falls within a range from approximately several mm to ten and several mm in the planar image display device. However, it is difficult to ensure the dielectric strength property in pulling out the anode lead and hence, a countermeasure to overcome this drawback has been desired.

Accordingly, the present invention has been made to overcome the drawbacks of the above-mentioned related art. The present invention is configured such that at least a portion of an anode lead line is made to penetrate a support body. The present invention can enhance the dielectric strength property by decreasing an exposed portion of the anode lead line thus providing an image display device which can perform a high quality display and can possess a prolonged lifetime.

Accordingly, a first aspect of the present invention is configured such that an anode lead line is arranged to penetrate a frame body. Due to such a constitution, an exposed portion of the anode lead line to which a high voltage is applied can be decreased and hence, the dielectric strength property can be enhanced thus providing an image display device which can perform a high quality display and can possess a prolonged lifetime.

A second aspect of the present invention is configured such that the anode lead line is arranged to penetrate the frame body from a top surface to bottom surface of the frame body. Due to such a constitution, the anode lead line is shielded over the whole length of the support body and hence, an exposed portion of the anode lead line to which a high voltage is applied can be decreased and hence, the generation of sparks is reduced whereby the dielectric strength property can be enhanced thus providing an image display device which can perform a high quality display and can possess a prolonged lifetime.

A third aspect of the present invention is configured such that the anode lead line is arranged to penetrate a back substrate. Due to such a constitution, a wiring length of the anode lead line can be shortened and hence, an exposed portion of the anode lead line to which a high voltage is applied can be decreased and hence, the dielectric strength property can be enhanced thus providing an image display device which can perform a high quality display and can possess a prolonged lifetime.

A fourth aspect of the present invention is configured such that an insulating material which wraps around the anode lead line is arranged at a portion of the anode lead line which penetrates the back substrate. Due to such a constitution, it is possible to take out the anode lead line in an insulating manner thus enhancing the dielectric strength property.

A fifth aspect of the present invention is configured such that the anode lead line has a relay terminal thereof arranged on a bottom surface side of the frame body. Due to such a constitution, it is possible to confirm the joining of the anode lead line at the time of sealing the frame body and the back substrate together thus ensuring the reliability of the connection. Further, it is possible to surely fix the anode lead line and, at the same time, it is possible to enhance the operation efficiency.

A sixth aspect of the present invention is configured such that the anode lead line is formed by using a material which has a linear thermal expansion coefficient substantially equal to a linear thermal expansion coefficient of the frame body. Due to such a constitution, it is possible to prevent the disconnection, the peeling off or the like of the anode lead line and hence, it is possible to ensure the reliability of operation.

A seventh aspect of the present invention is configured such that the frame body is formed of a collective body of a plurality of frame body members. Due to such a constitution, it is possible to facilitate the manufacturing of a large-sized display device and, at the same time, it is possible to enhance the mass productivity of the image display device using a size and a shape suitable for embedding an anode lead line.

An eighth aspect of the present invention is configured such that the frame body is formed of a collective body which is constituted of a plurality of frame body members which differ from each other in material. Due to such a constitution, it is possible to selectively use support body members made of materials suitable for embedding an anode lead line and hence, it is possible to enhance the efficiency of the embedding operation.

A ninth aspect of the present invention is configured such that the face substrate includes an anode terminal which is embedded in an inner surface side of the front substrate and is made conductive with the face electrode, wherein the anode lead line is connected to the anode terminal in a conductive manner. Due to such a constitution, it is possible to handle the front substrate as a plate, particularly in steps before a sealing step in manufacturing steps and hence, it is possible to enhance the operation efficiency.

A tenth aspect of the present invention is configured such that a connection-use conductive film is arranged between an anode terminal and a face electrode. Due to such a constitution, it is possible to prevent the dissipation of an anode thin film thus stabilizing the introduction of a high voltage thus providing an image display device which can perform a high quality display and can possess a prolonged lifetime.

An eleventh aspect of the present invention is configured such that the connection-use conductive film is mainly made of graphite. Due to such a constitution, it is possible to assure the conductivity and, at the same time, it is possible to create a high vacuum in a space defined by both substrates and the frame body by making use of characteristic of the graphite, that is, the small emission of gas thus providing an image display device which can perform a high quality display and can possess a prolonged lifetime.

A twelfth aspect of the present invention is configured such that the anode terminal and the anode lead line are detachably connected to each other. Due to such a constitution, it is possible to ensure the conductivity and to enhance the operability.

### BRIEF EXPLANATION OF DRAWINGS

FIG. 1A and FIG. 1B are views for explaining one embodiment of an image display device according to the present invention, wherein FIG. 1A is a plan view as viewed from a face substrate side and FIG. 1B is a side view of FIG. 1A;

FIG. 2 is a schematic plan view of aback substrate showing by removing a face substrate shown in FIG. 1A;

FIG. 3 is a schematic cross-sectional view taken along a line A-A in FIG. 1A;

FIG. 4 is a schematic cross-sectional view of the back substrate and a portion of the face substrate which corresponds to the back substrate taken along a line B-B in FIG. 2;

FIG. 5 is a schematic plan view as viewed from the back surface side showing a portion of FIG. 3 in an enlarged manner.

FIG. 6 is a schematic cross-sectional view showing another embodiment of the image display device of the present invention;

FIG. 7 is a schematic perspective view showing further another embodiment of the image display device of the present invention;

FIG. 8 is a schematic cross-sectional view taken along a line C-C in FIG. 7;

FIG. 9 is a schematic cross-sectional view showing further another embodiment of the image display device of the present invention;

FIG. 10A, FIG. 10B and FIG. 10C are views for explaining an example of electron sources which constitute pixels of the image display device of the present invention, wherein FIG. 10A is a plan view, FIG. 10B is a cross-sectional view taken along a line D-D in FIG. 10A, and FIG. 10C is a cross-sectional view taken along a line E-E in FIG. 10A; and

FIG. 11 is an explanatory view of an equivalent circuit example of the image display device to which the constitution of the present invention is applied.

### DESCRIPTION OF THE PREFERRED EMBODIMENTS

Hereinafter, embodiments of the present invention are explained in detail in conjunction with drawings showing the embodiments.

### Embodiment 1

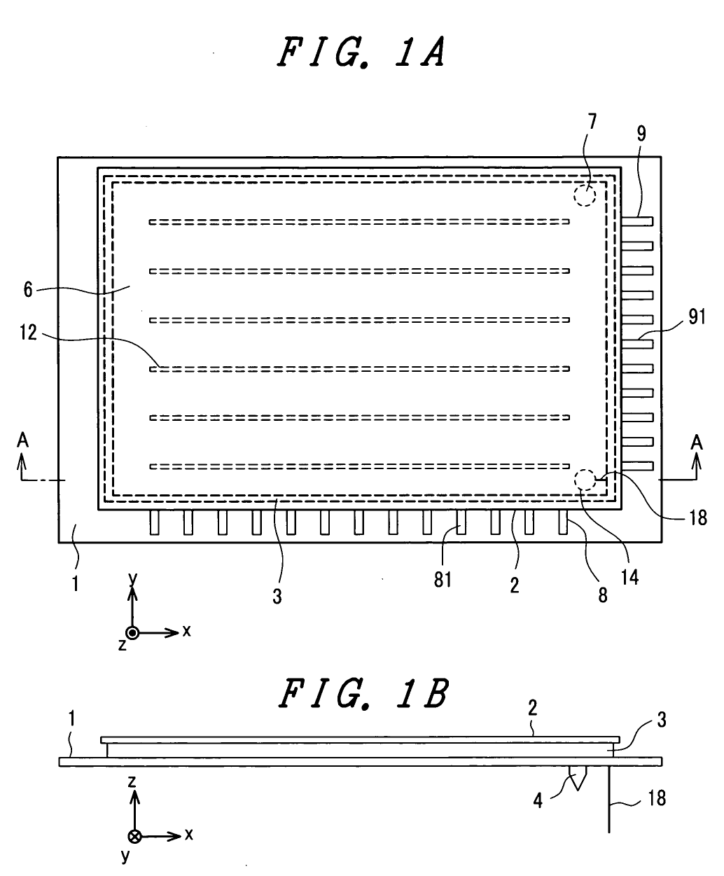

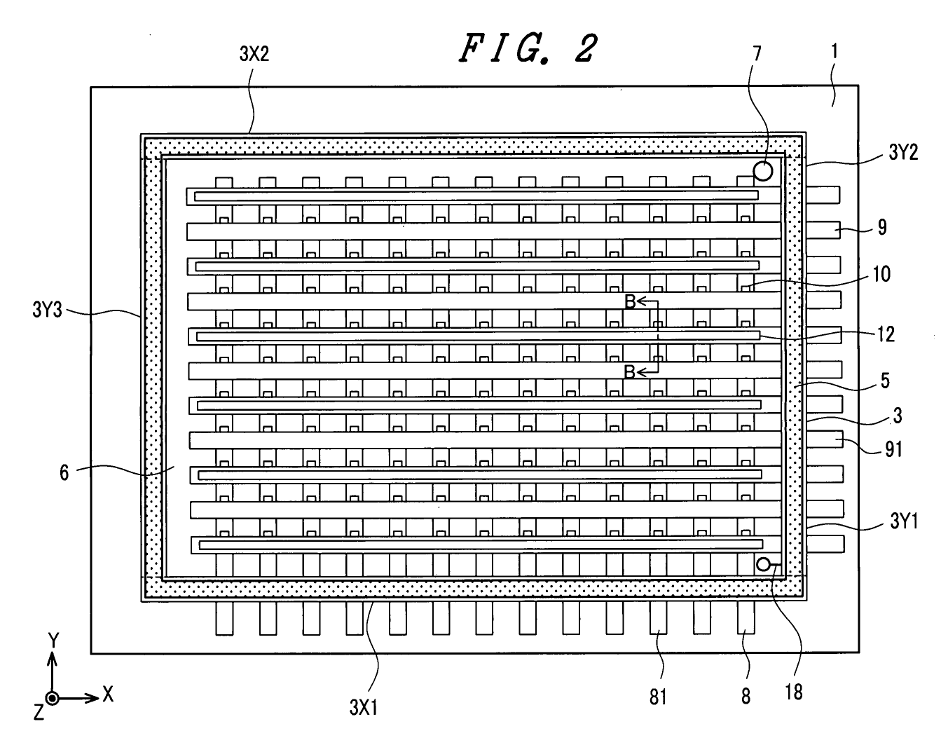

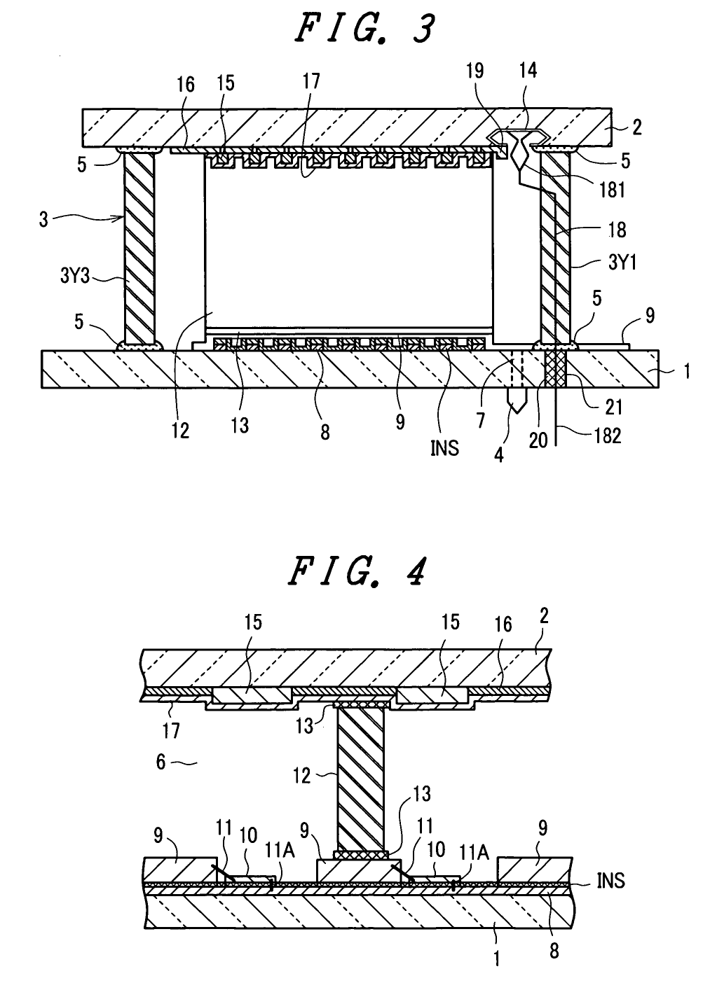

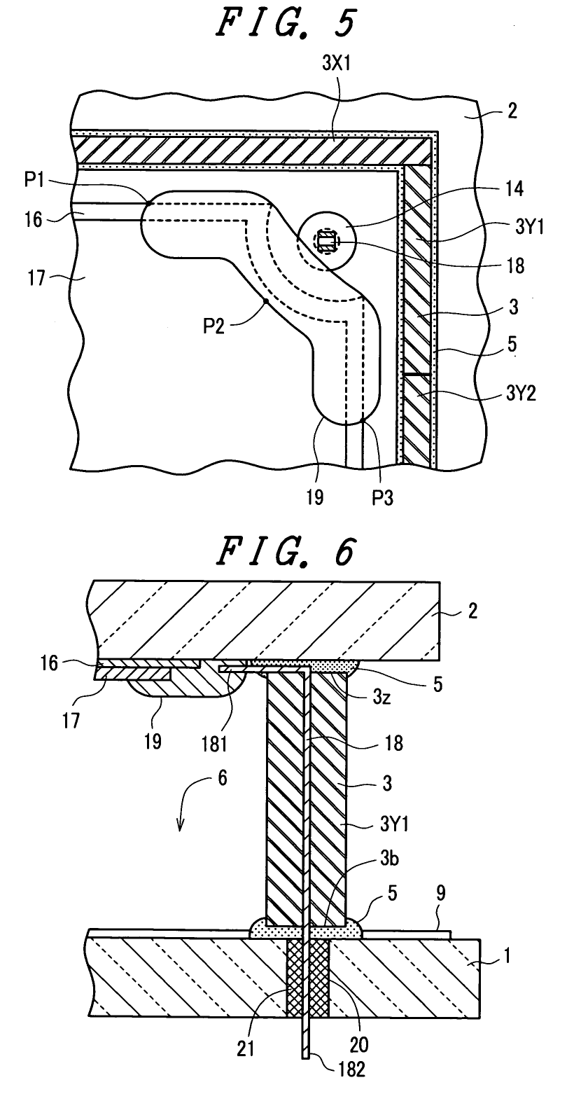

FIG. 1 to FIG. 5 are views for explaining one embodiment of an image display device according to the present invention. FIG. 1A is a plan view as viewed from a face substrate side, FIG. 1B is a side view of FIG. 1A, FIG. 2 is a schematic plan view of a back substrate by removing a face substrate shown in FIG. 1, FIG. 3 is a schematic cross-sectional view taken along a line A-A in FIG. 1A, FIG. 4 is a schematic cross-sectional view of a back substrate taken along a line B-B in FIG. 2 and a schematic cross-sectional view of the portion of a face substrate corresponding to the back substrate, and FIG. 5 is a schematic plan view of an essential part of an inner surface of the face substrate shown in FIG. 1A.

In these FIG. 1 to FIG. 5, numeral 1 indicates a back substrate and numeral 2 indicates a face substrate, wherein both substrates 1, 2 are formed of a glass plate having a thickness of several mm, for example, approximately 1 to 10 mm. Both substrates are formed in a substantially rectangular shape. The back substrate and the face substrate are stacked with a predetermined distance therebetween. Numeral 3 indicates a frame body. The frame body 3 is formed of, for example, a glass plate, a frit glass sintered body, a ceramic material or the like. The frame body 3 may be formed by combining a plurality of members and is formed in a substantially rectangular shape. Further, the frame body 3 is sandwiched by the above-mentioned both substrates 1, 2.

That is, the frame body 3 having a rectangular shape is formed of a pair of long-side frame body members 3X1, 3X2 which is arranged on long sides (extending in the X direction), a short-side frame body member 3Y3 which is arranged on one short side (extending in the Y direction) and two , that is, first, second split frame body members 3Y1, 3Y2 which are arranged on another side which faces the short-side frame body member 3Y3 in an opposed manner. A length obtained by adding a length of the first separated frame body members 3Y1 to a length of the second separated frame body members 3Y2 is approximately equal to a length of short side frame body member 3Y3. The frame body is constituted of the combination of five frame body members in total, wherein the frame body 3 is formed in an approximately rectangular frame shape by hermetically connecting these frame body members together. Further, these frame body members control the above-mentioned distance between both substrates 1, 2.

The frame body 3 having such a constitution is arranged between both substrates 1, 2 and is hermetically connected with both substrates 1, 2. It is needless to say that the frame body 3 may be constituted in a single body and, further, the frame body members 3X1 to 3Y2 may not be made of the same material.

Numeral 4 indicates an exhaust pipe. The exhaust pipe 4 is hermetically and fixedly mounted on the back substrate 1. Further, numeral 5 indicates a sealing material. The sealing material 5 is made of frit glass, for example, and joins the frame body 3 and both substrates 1, 2 thus hermetically sealing the space defined by the frame body 3 and both substrates 1, 2.

The space which is surrounded by the frame body 3, both substrates 1, 2 and the sealing material 5 is evacuated through the exhaust pipe 4 holding a degree of vacuum of, for example, 10⁻⁵ to 10⁻⁷ Torr. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed.

Numeral 8 indicates video signal lines and these video signal lines 8 extend in one direction (Y direction) and are arranged in parallel in another direction (X direction) on an inner surface of the back substrate 1. These video signal lines 8 penetrate a hermetically sealed portion between the long side frame body member 3X1 of the frame body 3 and the back substrate 1 and extend to an edge portion of the back substrate 1 on the long side. Distal end portions of the video signal lines 8 constitute image signal line lead terminals 81.

Next, numeral 9 indicates scanning signal lines. The scanning signal lines 9 extend over the video signal lines 8 in the above-mentioned another direction (X direction) which intersects the video signal lines 8 and are arranged in parallel in the above-mentioned one direction (Y direction). These scanning signal lines 9 penetrate a hermetically sealed portion between the first separated frame body member 3Y1 and the second separated frame body member 3Y2 of the frame body 3 and the back substrate 1 and extend to an edge portion of the back substrate 1 on the short-side side. Distal end portions of the scanning signal lines 9 constitute scanning signal line lead terminals 91.

Further, it is preferable to arrange the video signal lines 8, the scanning signal lines 9 and the through hole 7 such that a distance of at least 3 mm or more is ensured therebetween. When the distance between the video signal lines 8, the scanning signal lines 9 and the through hole 7 becomes smaller than this size, there exists a possibility that sizes of electrodes may fluctuate.

Next, numeral 10 indicates electron sources and the electron sources 10 are formed in the vicinity of respective intersecting portions of the scanning signal lines 9 and the video signal lines 8. The electron sources 10 are connected with the scanning signal lines 9 and the video signal lines 8 via connection lines 11, 11A respectively. Further, an interlayer insulation film INS is arranged between the video signal lines 8, the electron sources 10 and the scanning signal lines 9.

Here, the video signal lines 8 are formed of an Al/Nd film, for example, while the scanning signal lines 9 are formed of a Cr/Cu/Cr film or the like, for example.

Next, numeral 12 indicates spacers, wherein the spacers 12 are made of a ceramic material and are shaped in a rectangular thin plate shape. In this embodiment, the spacers 12 are arranged above the scanning signal lines 9 every other line, and are fixed to both substrates 1, 2 or to either one of substrates using an adhesive material 13. The spacers 12 are arranged at positions which do not impede operations of pixels.

Sizes of the spacers 12 are set based on sizes of substrates, a height of the frame body 3, materials of the substrates, an arrangement interval of the spacers, a material of spacers and the like. However, in general, the height of the spacers is approximately equal to a height of the frame body 3. A thickness of the spacer 12 is set to several 10 μm to several mm or less, while a length is set to approximately 20 mm to 1200 mm. Preferably, a practical value of the length is approximately 80 mm to 120 mm. Further, the spacers 12 possess a resistance value of approximately 10⁸ to 10⁹ Ω·cm.

Next, numeral 14 indicates a cup-shaped anode terminal. The anode terminal 14 is made of chromium alloy, for example, and is arranged in a state that the anode terminal 14 is embedded in an inner surface of the face substrate 2 which faces the back substrate 1 in an opposed manner. The anode terminal 14 is arranged at a position in the vicinity of a corner portion of the frame body 3 which does not impede a normal display. An opening portion end of the anode terminal 4 faces the evacuated space.

With respect to a method for embedding the anode terminal 14, this embodiment may adopt a method in which the anode terminal 14 is embedded in the inner surface of the face substrate 2 in a state that glass is wrapped around a portion of closed end surface side of the anode terminal 14 and, thereafter, a portion of the opening end side is exposed to the inner surface of the face substrate 2. Such embedding is performed when the substrate is still a glass plate, and after performing such embedding, pretreatment such as rinsing is performed and, thereafter, the substrate is fed to predetermined manufacturing steps.

Further, it is preferable to arrange the anode terminal 14 such that a distance of at least 3 mm or more can be ensured between the anode terminal 14 and the video signal line 8 and between the anode terminal 14 and the scanning signal line 9. When the distance between the anode terminal 14 and the video signal lines 8 or the distance between the anode terminal 14 and the scanning signal lines 9 becomes smaller than this size, there exists a possibility that an electrode size fluctuates.

Further, on the same surface side of the above-mentioned face substrate 2 to which the anode terminal 14 is arranged, phosphor layers 15 of red, green and blue are arranged in a state that these phosphor layers 15 are defined by a light-shielding BM (black matrix) film 16. A metal back 17 made of a metal thin film is formed in a state that the metal back 17 covers the phosphor layers 15 and the BM film 16 by a vapor deposition method, for example, thus forming a phosphor screen.

Further, with respect to a phosphor material of these phosphor layers 15, for example, Y₂O₂S:Eu (P22-R) is used as the red phosphor, ZnS:Cu,Al (P22-G) is used as the green phosphor, and ZnS:Ag,Cl (P22-B) is used as the blue phosphor. By mounting the anode on the face substrate, electrons radiated from the above-mentioned electron source 10 are accelerated and impinge on the phosphor layers 15 which constitute the corresponding pixels. Accordingly, the phosphor layer 15 emits light of the given color and the light is mixed with an emitted light of color of the phosphor of another pixel thus constituting the color pixel of a given color. Further, although the metal back 17 is indicated in a planar shape, the metal back 17 can be formed of stripe-like lines which are divided for every pixel column while intersecting the scanning signal lines 9.

Next, numeral 18 indicates an anode lead line and numeral 19 indicates a conductive film, wherein the conductive film 19 is arranged between the phosphor screen and the anode terminal 14 to which the anode lead line 18 is connected. The conductive film 19 is formed with a thickness larger than a thickness of the anode. Further, the anode lead line 18 has one end side 181 thereof detachably connected to the anode terminal 14 and another end side 182 pulled to the outside of the panel and is connected with a voltage source not shown in the drawing. The anode lead line 18 penetrates a portion of a first split frame body member 3Y1 of the frame body 3 and further penetrates a pull-out hole 20 formed in the back substrate 1.

The connection of the above-mentioned one end side 181 and the anode terminal 14 adopts the spring-like constitution having the structure in which one end side 181 is deformed by pressing and is inserted into the inside of the cut-like anode terminal 14 and, thereafter, the pressing is released so as to make one end side 181 expand and bring one end side 181 into resilient contact with the anode terminal 14 thus ensuring the contact between one end side 181 and the anode terminal 14. This spring-like constitution is required not to lose the spring property even after heat treatment at a temperature of approximately 450° C., for example.

Further, another end side 182 is used by sealing a dumet wire, for example, by taking a thermal expansion coefficient into consideration when the split frame body member 3Y1 is made of a glass material. Alternatively, when the split frame body member 3Y1 is made of a ceramic material, another end side 182 is formed by a conventionally known means such as the formation of another end side 182 by making use of an IC technique.

Further, an insulating material 21 such as a silicone material is filled and arranged in the inside of the pull-out hole 20 so as to make the insulating material 21 perform fixing and hermetic holding of another end side 182.

Next, the above-mentioned conductive film 19 is applied between a BM (black matrix) film 16 of the phosphor screen and a metal back 17 and the above-mentioned anode terminal 14, while the anode terminal 14, the BM film 16 and the metal back 17 are electrically connected with each other. The conductive film 19 is made of a graphite paste which contains graphite as a main component, for example, wherein a film thickness of the conductive film 19 is set to a value which falls within a range from several μm to twenty and some μm thus forming a thick film capable of ensuring the reliability in connection.

Further, it may be possible to form the conductive film 19 by applying a graphite paste using a means such as a brush, for example, wherein it is necessary to set a film thickness of the conductive film 19 to a value which falls within a range from several μm to twenty and some μm as mentioned previously and it is practical to set the film thickness to a value which falls within a range from approximately 5 μm to 10 μm. Further, with respect to a coating length, as shown in detail in FIG. 5, a creeping distance between the BM film 16 and the metal back 17 and the conductive film 19, that is, the creeping distance from a first contact point P1 between the BM film 16 and the conductive film 19 to a third contact point P3 by way of a contact point P2 between the conductive film 19 and the metal back film 17 at a center portion is set to a value which falls within a range from approximately several cm to several tens cm, wherein the coating length of 5 cm to 10 cm is practically used. Further, as a material of the conductive film 19, besides the above-mentioned graphite paste, a conductive metal paste such as a gold paste or a silver paste may be used.

Here, although the anode terminal and the anode lead line are detachably connected to each other in the above-mentioned case, it is needless to say that the anode terminal and the anode lead line may be fixed to each other by welding or the like.

According to the constitution of the embodiment 1, by covering and holding the anode lead line 18 with the frame body member 3Y1, it is possible to use a high voltage as an applied voltage by enabling the stable introduction of the high voltage and hence, the brightness can be also enhanced. Further, due to the constitution of the embodiment 1, the exposure of the high voltage potential can be reduced thus suppressing the generation of sparks or the like whereby it is possible to obtain an image display device which possesses a prolonged lifetime and high reliability.

Further, by achieving the holding and the hermetic holding of the anode lead line by filling the insulating material into the inside of the high voltage pull-out hole formed in the back substrate, it is possible to obtain the image display device which can perform the high-quality display by stabilizing the introduction of high voltage and can possess the prolonged life time.

Further, by establishing the electric connection between the anode terminal which is embedded in the face substrate with the BM film and the metal back using the conductive film, the reliability of the high voltage introducing portion can be ensured and hence, it is possible to obtain the image display device which can perform the high-quality display by stabilizing the introduction of high voltage and can possess the prolonged life time.

Further, by detachably connecting the anode terminal and the anode lead line, the operability can be enhanced and, at the same time, the number of heat treatment of the anode lead line can be reduced.

### Embodiment 2

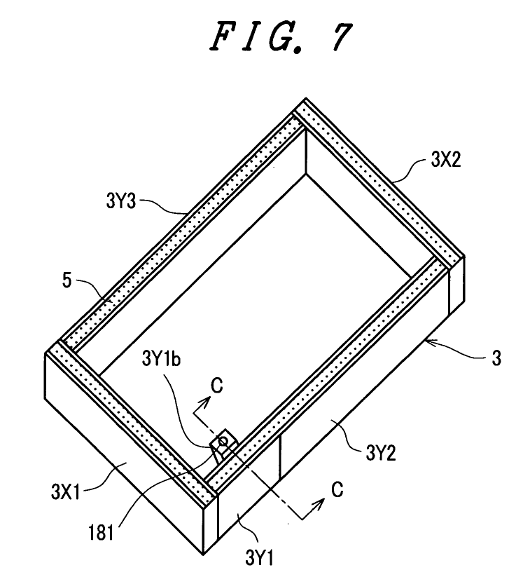

FIG. 6 is a schematic cross-sectional view showing another embodiment of the image display device of the present invention, wherein parts which are identical with the parts described in the above-mentioned drawings are given the same symbols. In FIG. 6, an anode lead line 18 is arranged in a penetrating manner from a top surface 3z to a bottom surface 3b of a split frame body member 3Y1, wherein one end side 181 is extended to a phosphor screen side and is connected in a conductive manner with the phosphor screen by means of a conductive film 19. On the other hand, another end side 182, in the same manner as the embodiment 1, penetrates a pull-out hole 20 and is extended to a voltage source.

According to the constitution of the embodiment 2, an exposure portion of the anode lead line is eliminated within a display region and hence, the anode lead line can be protected and, at the same time, it is possible to obtain an image display device which exhibits high quality by stabilizing the introduction of high voltage and can possess a prolonged life time. Further, it is possible to obtain an image display device which exhibits a prolonged life time and high reliability by suppressing the generation of sparks or the like.

### Embodiment 3

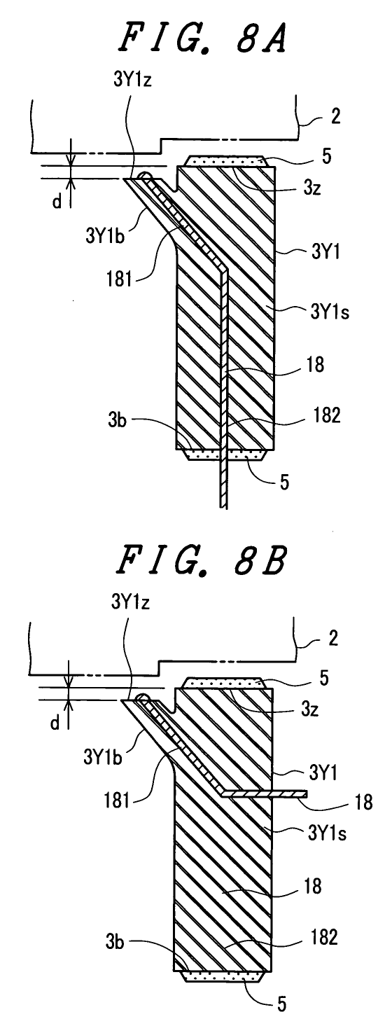

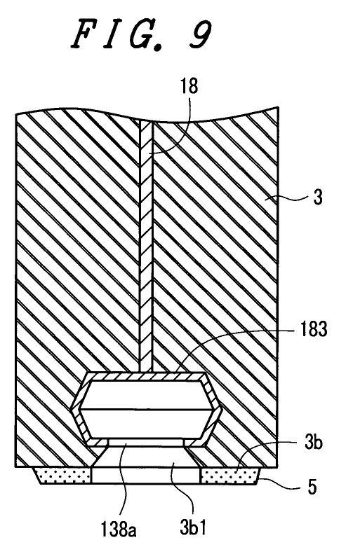

Next, FIG. 7, FIG. 8A and FIG. 8B are views showing further another embodiment of the image display device of the present invention, wherein FIG. 7 is a schematic perspective view of a frame body portion, and FIG. 8A is a schematic cross-sectional view taken along a line C-C in FIG. 7. In these drawings, parts which are identical with the parts described in the above-mentioned drawings are given the same symbols.

In FIG. 7 and FIG. 8A, a split frame body member 3Y1 includes a branch 3Y1b which projects toward a display region 6 side from a body portion 3Y1s, and an anode lead line 18 is configured to penetrate the inside of the branch 3Y1b and the body portion 3Y1s.

Further, a position of a top surface 3Y1z of the branch 3Y1b is set lower than a top portion 3z of the body portion 3Y1s thus forming a step d between both top surfaces. On the other hand, by providing a step in the reverse direction proper to eliminate the above-mentioned step d on a face substrate 2 which faces the split support body member 3Y1, it is possible to suppress undesired fluidity of a sealing material 5 to a display region side.

According to the constitution of the embodiment 3, by arranging one end side 181 of the anode lead line 18 in a spaced apart manner from the hermetically sealing portion between the frame body 3 and a face substrate 2, it is possible to protect the anode lead line and, at the same time, it is possible to obtain an image display device which can stabilize the introduction of high voltage and can exhibit high quality and a prolonged life time. Further, it is possible to obtain an image display device which exhibits a prolonged life time and high reliability by suppressing the generation of sparks or the like. FIG. 8B is a schematic cross-sectional view taken along a line C-C in FIG. 7 and FIG. 8B is different example from FIG. 8A. The anode lead line 18 penetrates to the side wall of frame body 3.

### Embodiment 4

Next, FIG. 9 is a schematic cross-sectional view of a frame body portion and a back substrate showing further another embodiment of the image display device of the present invention, wherein parts which are identical with the parts described in the above-mentioned drawings are given the same symbols.

In FIG. 9, an anode lead line 18 is configured such that a relay terminal 183 is arranged in the inside of a frame body 3 in an embedded manner.

The relay terminal 183 constitutes a portion of the anode lead line 18 and is arranged in the inside of an opening 3b1 formed in a bottom surface 3b of the frame body 3 in an embedded manner, wherein the relay terminal 183 has an opening 183a on aback substrate 1 side, and constitutes a cup-shaped conductive relay terminal having the substantially equal constitution with the above-mentioned anode terminal 14.

The relay terminal 183 can be used in a state that further another portion of the anode lead line which is arranged in a high voltage lead hole formed in the back substrate in a penetrating manner, for example, is engaged with the relay terminal 183.

According to the constitution of the embodiment 4, by arranging the relay terminal 183 in the frame body 3, the sealing operation of the back substrate 1 and the frame body 3 can be facilitated and, at the same time, the anode lead line can be protected and hence, it is possible to obtain an image display device which can stabilize the introduction of high voltage and can exhibit high quality and a prolonged lifetime. Further, it is possible to obtain an image display device which exhibits a prolonged life time and high reliability by suppressing the generation of sparks or the like.

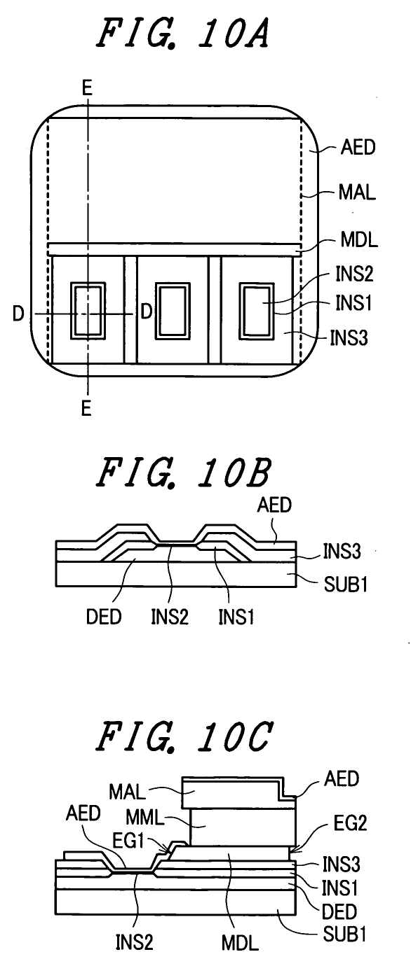

FIG. 10A, FIG. 10B and FIG. 10C are views for explaining an example of electron sources 10 which constitutes pixels of the image display device of the present invention, wherein FIG. 10A is a plan view, FIG. 10B is a cross-sectional view taken along a line D-D in FIG. 10A, and FIG. 10C is a cross-sectional view taken along a line E-E in FIG. 10A. The electron sources are formed of an MIM electron source.

The structure of the electron source is explained in conjunction with manufacturing steps. First of all, on the back substrate SUB1, lower electrodes DED to which the video signal is applied, a protective insulation layer INS1, an insulation layer INS2 are formed. Next, an interlayer film INS3, upper bus electrodes AED to which the scanning signal is applied and a metal film which constitutes a spacer electrode for arranging spacers 12 are formed by a sputtering method, for example. Although the lower electrodes and the upper electrodes are made of aluminum, these electrodes may be made of other metal described later.

The interlayer film INS3 may be made of silicon oxide, silicon nitride film, silicon or the like, for example. Here, the interlayer film INS3 is made of silicon nitride film and has a film thickness of 100 nm. The interlayer film INS3, when a pin hole is formed in a protective insulation layer INS1 formed by anodizing, fills a void and plays a role of ensuring the insulation between a lower electrode DED and an upper bus electrode (a three-layered laminated film which sandwiches Cu which constitutes a metal film intermediate layer MML between a metal film lower layer MDL and a metal film upper layer MAL) which constitutes a scanning signal electrode.

Here, the upper bus electrode AED is not limited to the above-mentioned three-layer laminated film and the number of layers may be increased more. For example, the metal film lower layer MDL and the metal film upper layer MAL may be made of a metal material having high oxidation resistance such as aluminum (Al), chromium (Cr), tungsten (W), molybdenum (Mo) or the like, an alloy containing such metal, or a laminated film of these metals. Here, the metal film lower layer MDL and the metal film upper layer MAL are made of an alloy of Al—Nd. Besides the alloy, with the use of a five-layered film in which the metal film lower layer MDL is a laminated film formed of an Al alloy and Cr, W, MO or the like, the metal film upper layer MAL is a laminated film formed of Cr, W, Mo or the like and an Al alloy, and films which are brought into contact with the metal film intermediate layer MML made of Cu are made of a high-melting-point metal, in a heating step of a manufacturing process of the image display device, the high-melting-point metal functions as a barrier film thus preventing Al and Cu from being alloyed whereby the five-layered film is particularly effective in the reduction of resistance.

When the metal film lower layer MDL and the metal film upper layer MAL are made of only Al—Nd alloy, a film thickness of the Al—Nd alloy in the metal film upper layer MAL is larger than a film thickness of the Al—Nd alloy in the metal film lower layer MDL, and a thickness of Cu of the metal film intermediate layer MML is made as large as possible to reduce the wiring resistance. Here, the film thickness of the metal film lower layer MDL is 300 nm, the film thickness of the metal film intermediate layer MML is 4 μm, and the film thickness of the metal film upper layer MAL is 450 nm. Here, Cu in the metal film intermediate layer MML can be formed by electrolytic plating or the like besides sputtering.

With respect to the above-mentioned five-layered film which uses high-melting-point metal, in the same manner as Cu, it is particularly effective to use a laminated film which sandwiches Cu with Mo which can be etched by wet etching in a mixed aqueous solution of phosphoric acid, acetic acid and nitric acid as the metal film intermediate layer MML. In this case, a film thickness of Mo which sandwiches Cu is set to 50 nm, a film thickness of the Al alloy of the metal film lower layer MDL which sandwiches the metal film intermediate layer MML together with the metal film upper layer MAL is 300 nm, and the film thickness of the Al alloy of the metal film upper layer MAL which sandwiches the metal film intermediate layer MML together with the metal film lower layer MDL is 50 nm.

Subsequently, the metal film upper layer MAL is formed in a stripe shape which intersects the lower electrode DED by performing the patterning of resist by screen printing and etching. In performing the etching, for example, a mixed aqueous solution of phosphoric acid and acetic acid is used for wet etching. By excluding the nitric acid from the etchant, it is possible to selectively etch only the Al—Nd alloy without etching Cu.

Also in case of the five-layered film which uses Mo, by excluding the nitric acid from the etchant, it is possible to selectively etch only the Al—Nd alloy without etching Mo and Cu. Here, although one metal film upper layer MAL is formed per one pixel, two metal film upper layers MAL may be formed per pixel.

Subsequently, by using the same resist film directly or using the Al—Nd alloy of the metal film upper layer MAL as a mask, Cu of the metal film intermediate layer MML is etched by wet etching using a mixed aqueous solution of phosphoric acid, acetic acid and nitric acid. Since an etching speed of Cu in the etchant made of mixed aqueous solution of phosphoric acid, acetic acid and nitric acid is sufficiently fast compared to an etching speed of the Al—Nd alloy and hence, it is possible to selectively etch only Cu of the metal film intermediate layer MML. Also in case of the five-layered film which uses Mo, the etching speeds of Mo and Cu are sufficiently fast compared to an etching speed of the Al—Nd alloy and hence, it is possible to selectively etch only the three-layered film made of Mo and Cu. In etching Cu, besides the above-mentioned aqueous solution, an ammonium persulfate aqueous solution, a sodium persulfate aqueous solution can be effectively used.

Subsequently, the metal film lower layer MDL is formed in a stripe shape which intersects the lower electrode DED by performing the patterning of resist by screen printing and etching. The etching is performed by wet etching using a mixed aqueous solution of phosphoric acid and acetic acid. Here, by displacing the position of the printing resist film from the stripe electrode of the metal film upper layer MAL in the parallel direction, one-side EG1 of the metal film lower layer MDL projects from the metal film upper layer MAL thus forming a contact portion to ensure the connection with the upper electrode AED in a later stage. Accordingly, on the opposite side EG2 of the metal film lower layer MDL, using the metal film upper layer MAL and the metal film intermediate layer MML as masks, the over-etching is performed and hence, a retracting portion is formed on the metal film intermediate layer MML as if eaves are formed.

Due to the eaves of the metal film intermediate layer MML, the upper electrode AED which is formed as a film in a later step is separated. Here, since the film thickness of the metal film upper layer MAL is set larger than the film thickness of the metal film lower layer MDL and hence, even when the etching of the metal film lower layer MDL is finished, it is possible to allow the metal film upper layer MAL to remain on Cu of the metal film intermediate layer MML. Due to such a constitution, it is possible to protect a surface of Cu with the metal film upper layer MAL and hence, it is possible to ensure the oxidation resistance even when Cu is used. Further, it is possible to separate the upper electrode AED in a self-aligning manner and it is possible to form the upper bus electrodes which constitute scanning signal lines which perform the supply of electricity. Further, in case that the metal film intermediate layer MML is formed of the five-layered film which sandwiches Cu with Mo, even when the Al alloy of the metal film upper layer MAL is thin, Mo suppresses the oxidation of Cu and hence, it is not always necessary to make the film thickness of the metal film upper layer MAL larger than the film thickness of the metal film lower layer MDL.

Subsequently, electron emission portions are formed as openings in the interlayer film INS3. The electron emission portion is formed in a portion of an intersecting portion of a space which is sandwiched by one lower electrode DED inside the pixel and two upper bus electrodes (a laminated film consisting of metal film lower layer MDL, metal film intermediate layer MML, and metal film upper layer MAL and a laminated film consisting of metal film lower layer MDL, metal film intermediate layer MML, and metal film upper layer MAL of neighboring pixel not shown in the drawing) which intersect the lower electrode DED. The etching is performed by dry etching which uses an etching gas containing CF₄ and SF₆ as main components, for example.

Finally, the upper electrode AED is formed as a film. The upper electrode AED is formed by a sputtering method. The upper electrode AED may be made of aluminum or a laminated film made of Ir, Pt and Au, wherein a film thickness may be 6 nm, for example. Here, the upper electrode AED is, at one portion (right side in FIG. 10C) of two upper bus electrodes (a laminated film consisting of a metal film lower layer MDL, a metal film intermediate layer MML and a metal film upper layer MAL) which sandwich the electron emission portions, cut by a retracting portion (EG2) of the metal film lower layer MDL formed by the eaves structure of the metal film intermediate layer MML and the metal film upper layer MAL. Then, at another portion (left side in FIG. 10C) of the upper bus electrodes, the upper electrode AED is formed and is connected with the upper bus electrode (the laminated film consisting of the metal film lower layer MDL, the metal film intermediate layer MML and the metal film upper layer MAL) by a contact portion (EG1) of the metal film lower layer MDL without causing a disconnection thus providing the structure which supplies electricity to the electron emission portions.

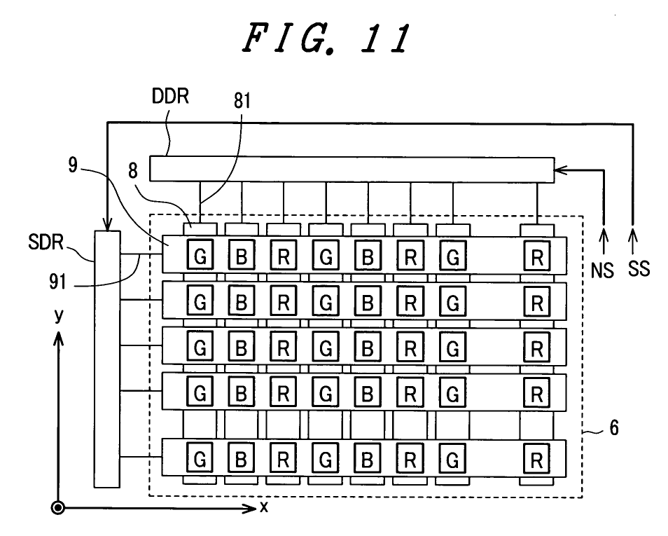

Next, FIG. 11 is an explanatory view of an example of an equivalent circuit of an image display device to which the constitution of the present invention is applied. A region depicted by a broken line in FIG. 11 indicates a display region 6. In the display region 6, n pieces of video signal lines 8 and m pieces of scanning signal lines 9 are arranged in a state that these lines intersect each other thus forming matrix of n×m. Sub pixels are formed over the respective intersecting portions of the matrix and one group consisting of three unit pixels (or sub pixels) “R”, “G”, “B” in the drawing constitutes one color pixel. Here, the constitution of the electron sources is omitted from the drawing. The video signal lines 8 are connected to the video signal drive circuit DDR through the video signal line lead terminals 81, while the scanning signal lines 9 are connected to the scanning signal drive circuit SDR through the scanning signal line lead terminal 91. The video signal NS is inputted to the video signal drive circuit DDR from an external signal source, while the scanning signal SS is inputted to the scanning signal drive circuit SDR in the same manner.

Due to such a constitution, by supplying the video signal to the video signal lines 8 which intersect the scanning signal lines 9 which are sequentially selected, it is possible to display a two-dimensional full color image. With the use of the display panel having this constitution, it is possible to realize the image display device at a relatively low voltage with high efficiency.

What is claimed is:

1. An image display device comprising:
a back substrate which includes a plurality of first lines which extend in the first direction and are arranged in parallel in the second direction which intersects the first direction, an insulation film which is formed in a state that the insulation film covers the first lines, a plurality of second lines which extend in the second direction and are arranged in parallel in the first direction over the insulation film, and electron sources which are connected to the first lines and the second lines;
a face substrate which includes phosphor layers of plurality of colors which emit light due to excitation thereof by electrons emitted from the electron sources and a front electrode, the face substrate facing the back substrate with a predetermined distance therebetween;
a frame body which is arranged between the back substrate and the face substrate and surrounds a display region;
a sealing material which hermetically seals a top surface and a bottom surface of the frame body to the face substrate and the back substrate respectively; and
an anode lead line which is arranged between the face substrate and a voltage power source and is configured to penetrate the frame body.

2. An image display device according to claim 1, wherein the anode lead line penetrates the frame body from a top surface to a bottom surface of the frame body.

3. An image display device according to claim 1, wherein the anode lead line is penetrates the back substrate.

4. An image display device according to claim 3, wherein an insulating material which wraps around the anode lead line is arranged at a portion of the anode lead line which penetrates the back substrate.

5. An image display device according to claim 1, wherein the anode lead line arranges a relay terminal thereof on a bottom surface side of the frame body.

6. An image display device according to claim 1, wherein the anode lead line is formed by using a material which has a thermal expansion coefficient substantially equal to a thermal expansion coefficient of the frame body.

7. An image display device according to claim 1, wherein the frame body is formed of a collective body which is constituted of a plurality of frame body members.

8. An image display device according to claim 7, wherein the frame body is formed of a collective body which is constituted of a plurality of frame body members which differ from each other in material.

9. An image display device according to claim 1, wherein the face substrate includes an anode terminal which is embedded into an inner surface side thereof and is made conductive with the face electrode and the anode lead line is connected with the anode terminal in a conductive manner.

10. An image display device according to claim 9, wherein a connection-use conductive film is arranged between the anode terminal and the face electrode.

11. An image display device according to claim 10, wherein the connection-use conductive film contains graphite as a main content.

12. An image display device according to claim 9, wherein the anode terminal and the anode lead line are detachably connected with each other.
